(19) United States
(12) Patent Application Publication
(10) Pub. No.: US 2023/0182988 A1
(43) Pub. Date: Jun. 15, 2023

(54) SYSTEM AND METHODS FOR DELIVERING A LIQUID

(71) Applicant: Amtronics LLC, San Marcos, TX (US)

(72) Inventors: Andrew ROBINSON, San Marcos, TX (US); Krishna KOWLGI, San Marcos, TX (US); Nathan BARREE, San Marcos, TX (US)

(21) Appl. No.: 18/077,133

(22) Filed: Dec. 7, 2022

Related U.S. Application Data
(60) Provisional application No. 63/287,889, filed on Dec. 9, 2021.

(51) Int. Cl. B65D 81/34

(52) U.S. Cl. CPC B65D 81/3484; B65D 2581/34

(57) ABSTRACT

A temperature controller assembly is configured to heat and cool liquid within a container. The temperature control assembly has a printed circuit board electrically coupled to a battery, a heat exchanger, and a control switch. A container is mechanically coupled to the heat exchanger and has a volume less than 30 ml. The battery has a battery capacity of 18.5A-h such that when connected to a 3.7 V output to the heat exchanger the battery provides approximately 60-80 watt-hours of energy to the heat exchanger to heat or cool the liquid in the container.

### BACKGROUND

The embodiments herein relate generally to devices that contain liquids.

### SUMMARY

A temperature controller assembly is configured to heat and cool liquid within a container. The temperature control assembly has a printed circuit board electrically coupled to a battery, a heat exchanger, and a control switch. A container is mechanically coupled to the heat exchanger and has a volume less than 30 ml. The battery has a battery capacity of 18.5A-h such that when connected to a 3.7 V output to the heat exchanger the battery provides approximately 60-80 watt-hours of energy to the heat exchanger to heat or cool the liquid in the container.

In some embodiments, a mouthpiece can be joined to the container. A storage module can be arranged within the container. A push button can be arranged on the container proximate the storage module. An electronics storage compartment can be arranged against the mouthpiece, the container and the heat exchanger. The electronics storage compartment houses the printed circuit board. A power button, the control switch, and a charging port can be arranged on an outer surface of the electronics storage compartment and electrically coupled to the printed circuit board.

### BRIEF DESCRIPTION OF THE FIGURES

The detailed description of some embodiments of the invention is made below with reference to the accompanying figures, wherein like numerals represent corresponding parts of the figures.

FIG. 1 shows a perspective view of one embodiment of the present invention;

FIG. 2 shows a rear view of one embodiment of the present invention; and

FIG. 3 shows a perspective view of one embodiment of a flow chart of the invention.

### DETAILED DESCRIPTION OF CERTAIN EMBODIMENTS

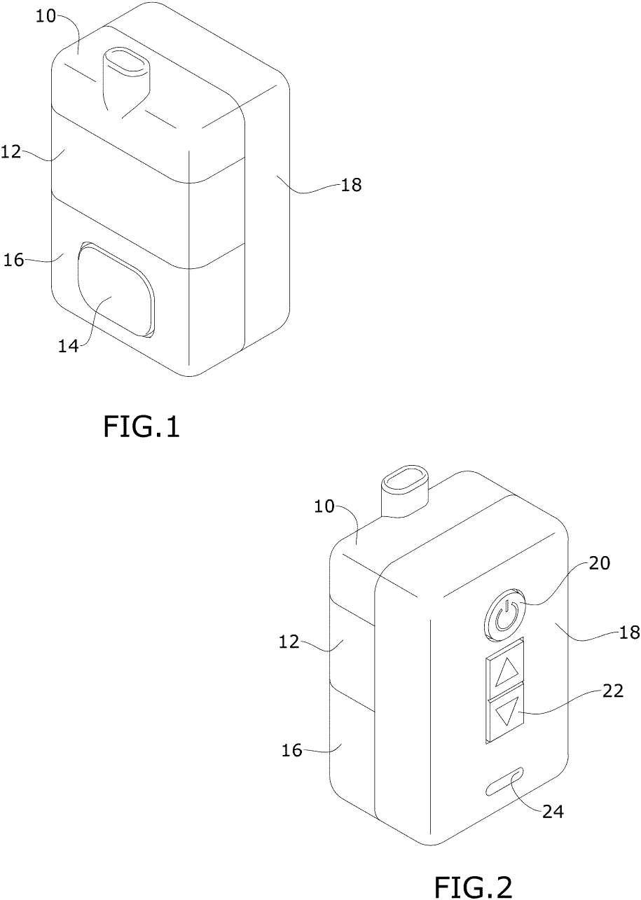

By way of example, and referring to FIG. 1, one embodiment of a temperature controller assembly is configured to heat and cool liquid within a container 16. The temperature control assembly has a printed circuit board electrically coupled to a battery, a heat exchanger 12, and a control switch 22. A container 16 is mechanically coupled to the heat exchanger 12 and has a volume less than 30 ml. The battery has a battery capacity of 18.5A-h such that when connected to a 3.7 V output to the heat exchanger 12 the battery provides approximately 60-80 watt-hours of energy to the heat exchanger 12 to heat or cool the liquid in the container 16.

In some embodiments, a mouthpiece 10 can be joined to the container 16. A storage module can be arranged within the container. A push button 14 can be arranged on the container proximate the storage module. An electronics storage compartment 18 can be arranged against the mouthpiece 10, the container 16 and the heat exchanger 12. The electronics storage compartment 18 houses the printed circuit board. A power button 20, the control switch 22, and a charging port 24 can be arranged on an outer surface of the electronics storage compartment 18 and electrically coupled to the printed circuit board.

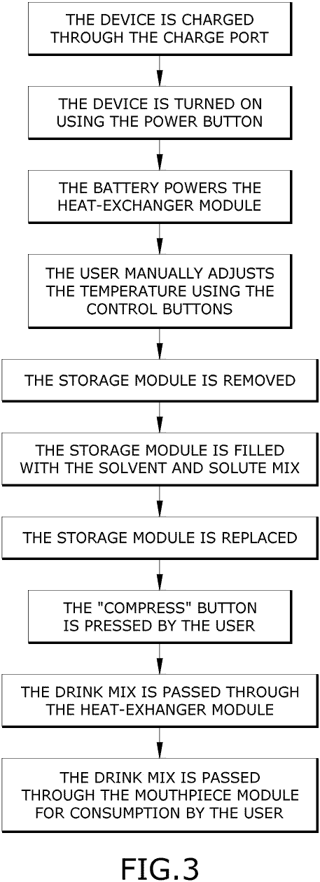

Turning to FIG. 3, the temperature controller assembly is charged through the charging port 24. Then, the temperature controller assembly is turned on using the power button 20. After that, the battery powers the heat exchanger 12. Following that, the user manually adjusts the temperature using the control switch 22. Subsequently, the storage container 16 is removed. The storage container 16 is filled with the solvent and solute mix. Next, the storage container 16 is replaced. A user can then press the push button 14. A drink mix is passed through the heat exchanger 12. The drink mix is passed through the mouthpiece 10 for consumption by the user.

As used in this application, the term “a” or “an” means “at least one” or “one or more.”

As used in this application, the term “about” or “approximately” refers to a range of values within plus or minus 10% of the specified number.

As used in this application, the term “substantially” means that the actual value is within about 10% of the actual desired value, particularly within about 5% of the actual desired value and especially within about 1% of the actual desired value of any variable, element or limit set forth herein.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

Any element in a claim that does not explicitly state “means for” performing a specified function, or “step for” performing a specified function, is not to be interpreted as a “means” or “step” clause as specified in 35 U.S.C. § 112, 6. In particular, any use of “step of ” in the claims is not intended to invoke the provision of 35 U.S.C. § 112, 6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A temperature controller assembly, configured to heat and cool liquid within a container; the temperature control assembly comprising:
a printed circuit board, electrically coupled to a battery, a heat exchanger, and a control switch,
a container, mechanically coupled to the heat exchanger and having a volume less than 30 ml;
wherein the battery has a battery capacity of 18.5A-h such that when connected to a 3.7 V output to the heat exchanger the battery provides approximately 60-80 watt-hours of energy to the heat exchanger to heat or cool the liquid in the container.

2. The temperature controller assembly of claim 1, a mouthpiece joined to the container.

3. The temperature controller assembly of claim 2, further comprising a storage module arranged within the container.

4. The temperature controller assembly of claim 3, further comprising a button, arranged on the container proximate the storage module.

5. The temperature controller assembly of claim 4, further comprising an electronics storage compartment, arranged against the mouthpiece, the container and the heat exchanger; wherein the electronics storage compartment houses the printed circuit board.

6. The temperature controller assembly of claim 4, further comprising a power button, the control switch, and a charging port arranged on an outer surface of the electronics storage compartment and electrically coupled to the printed circuit board.
